(19) United States
(12) Patent Application Publication
(10) Pub. No.: US 2026/0161151 A1
(43) Pub. Date: Jun. 11, 2026

(54) HYPER-INTEGRATED DATA DEVICES WITH RADIATION TOLERANCE

(71) Applicant: Microchip Technology Inc., Chandler, AZ (US)

(72) Inventors: Nian Yang, Mountain View, CA (US); Bomy Chen, Newark, CA (US); Steve Nagel, Chandler, AZ (US)

(73) Assignee: Microchip Technology Inc., Chandler, AZ (US)

(21) Appl. No.: 19/443,416

(22) Filed: Jan. 8, 2026

Related U.S. Application Data
(63) Continuation-in-part of application No. 18/680,129, filed on May 31, 2024.
(60) Provisional application No. 63/563,243, filed on Mar. 8, 2024.

(51) Int. Cl. G05B 19/4099

(52) U.S. Cl. CPC G05B 19/4099; G05B 2219/45031

(57) ABSTRACT

Methods to form a three-dimensional semiconductor package comprising a customized ultra-bandwidth elements (CUBE) die coat shielding particles with an electrically insulating coating, disperse the coated shielding particles in a base material to form a mold structure; and position the mold structure proximate the three-dimensional semiconductor package to shield the package from radiation. Devices comprising: a three-dimensional semiconductor package; and a mold structure proximate the three-dimensional semiconductor package, the mold structure comprising: a base material; and shielding particles comprising an electrically insulating coating, wherein the shielding particles are dispersed in the base material.

### PRIORITY STATEMENT

This application is a continuation-in-part application of U.S. application Ser. No. 18/680,129, filed May 31, 2024, which claims priority to U.S. Provisional Ser. No. 63/563,243 , filed Mar. 8, 2024, the contents both of which are hereby incorporated in their entirety for all purposes.

### TECHNICAL FIELD

The present disclosure relates to radiation shielded three-dimensional semiconductor packages, in particular, semiconductor packages comprising a shielding compound having shielding particles coated with an electrical insulation coating and dispersed in a base material.

### BACKGROUND

Artificial intelligence (AI) and datacenter solutions (DCS) hardware components employ huge amount of double data rate (DDR) volatile memory for short term data access and solid state drive (SSD) non-volatile memory for long term data storage. NAND is the name for a type of flash memory where memory cells are built using this NOT-AND logic configuration. This non-volatile memory retains data even when power is off, making it ideal for storage devices. Microcontroller (μC), DDR, and NAND are all components of solid-state drives (SSDs), where NAND is the flash memory for storing data, a microcontroller (μC) manages the drive, and DDR (like DRAM) is an optional component that acts as a high-speed cache. SSDs are under constant workload for data center customers. These individual semiconductor devices can have anywhere between 10s to 1000s of NAND dies and 100's of DDR dies in it as memory media. These media are susceptible to the radiation impacts. There is a growing need for Radiation Tolerant (RT) semiconductors for applications like data center solutions

There is a need for highly integrated memory/storage stacks with radiation resistance for datacenter solutions.

### SUMMARY

According to aspects, there is provided a method comprising: forming a three-dimensional semiconductor package comprising a customized ultra-bandwidth elements (CUBE) die: coating shielding particles with an electrically insulating coating; dispersing the coated shielding particles in a base material to form a mold structure; and positioning the mold structure proximate the three-dimensional semiconductor package.

Aspects as in the preceding paragraph provide a method, wherein forming a three-dimensional semiconductor package comprises: providing a package substrate; mounting a CUBE die in signal communication with the package substrate, wherein the CUBE die comprises double data rate (DDR) volatile memory; mounting a front die in signal communication the CUBE die, wherein the front die comprises NAND memory cells; and mounting a controller die in signal communication with the front die.

Aspects as in one of the preceding two paragraphs provide a method, wherein the CUBE die comprises DRAM and NAND in a ratio of 1:4, 1:2, or 1:1, and wherein the CUBE die comprises double data rate (DDR) volatile memory with a refresh rate of 64 milliseconds, 6 milliseconds, 0.06 milliseconds, or 0.64 microseconds.

Aspects as in one of the preceding three paragraphs provide a method, wherein the shielding particles comprise at least one of boron nitride (BN), bismuth (Bi), bismuth oxide (Bi₂O₃), tantalum nitride (TaN), tungsten nitride (W₃N₂), tin oxide (SnO₂), copper (I) oxide (Cu₂O), or copper (II) oxide (CuO).

Aspects as in one of the preceding four paragraphs provide a method, wherein the shielding particles comprise a material from at least one of the Cobalt oxide family, the Nickle oxide family, the Neodymium oxide family, and the Iron oxide family.

Aspects as in one of the preceding five paragraphs provide a method, wherein the electrically insulating coating comprises silicon dioxide (SiO₂).

Aspects as in one of the preceding six paragraphs provide a method, wherein the base material comprises polymer, silicone, polyurethane, chloroprene, butyl, polybutadiene, neoprene, natural rubber, isoprene, resin, or epoxy.

Aspects as in one of the preceding seven paragraphs provide a method, comprising dispersing a plurality of silicon dioxide (SiO₂) filler particles in the base material to form the mold structure, wherein dispersed particles comprise 50% to 95% shielding particles and 50% to 5% silicon dioxide filler particles.

Aspects as in one of the preceding eight paragraphs provide a method, wherein positioning the mold structure proximate the three-dimensional semiconductor package comprises comprising positioning first and second shielding layers, wherein the first and second shielding layers comprise different concentrations of the coated shielding particles.

According to aspects, there is provided a device comprising: a three-dimensional semiconductor package comprising a CUBE die; and a mold structure proximate the three-dimensional semiconductor package, the mold structure comprising: a base material; and shielding particles comprising an electrically insulating coating, wherein the shielding particles are dispersed in the base material.

Aspects as in the preceding paragraph provide a device, wherein the three-dimensional semiconductor package comprises: a package substrate; a CUBE die in signal communication with the package substrate, wherein the CUBE die comprises double data rate (DDR) volatile memory; a front die in signal communication the CUBE die, wherein the front die comprises NAND memory cells; and a controller die in signal communication with the front die.

Aspects as in one of the preceding two paragraphs provide a device, wherein the CUBE die comprises DRAM and NAND in a ratio of 1:4, 1:2, or 1:1, and wherein the CUBE die comprises double data rate (DDR) volatile memory with a refresh rate of 64 milliseconds, 6 milliseconds, 0.06 milliseconds, or 0.64 microseconds.

Aspects as in one of the preceding three paragraphs provide a device, wherein the shielding particles comprise at least one of boron nitride (BN), bismuth (Bi), bismuth oxide (Bi₂O₃), tantalum nitride (TaN), tungsten nitride (W₃N₂), tin oxide (SnO₂), copper (I) oxide (Cu₂O), or copper (II) oxide (CuO).

Aspects as in one of the preceding four paragraphs provide a device, wherein the shielding particles comprise a material from at least one of the Cobalt oxide family, the Nickle oxide family, the Neodymium oxide family, and the Iron oxide family.

Aspects as in one of the preceding five paragraphs provide a device, wherein the electrically insulating coating comprises silicon dioxide (SiO₂).

Aspects as in one of the preceding six paragraphs provide a device, wherein the base material comprises a material selected from polymer, silicone, polyurethane, chloroprene, butyl, polybutadiene, neoprene, natural rubber, isoprene, resin, and epoxy.

Aspects as in one of the preceding seven paragraphs provide a device, wherein the mold structure comprises silicon dioxide (SiO₂) filler particles, wherein particles in the mold structure comprise 50% to 95% shielding particles and 50% to 5% silicon dioxide (SiO₂) filler particles.

Aspects as in one of the preceding eight paragraphs provide a device, comprising an encapsulate at least partially encapsulating the three-dimensional semiconductor package, wherein the mold structure is proximate the encapsulate.

Aspects as in one of the preceding nine paragraphs provide a device, wherein the mold structure comprises first and second shielding layers, wherein the first and second shielding layers comprise different concentrations of shielding particles.

According to aspects, there is provided a system comprising: a three-dimensional semiconductor package comprising: a package substrate; a CUBE die in signal communication with the package substrate, wherein the CUBE die comprises double data rate (DDR) volatile memory; a front die in signal communication the CUBE die, wherein the front die comprises NAND memory cells; and a controller die in signal communication with the front die; and a mold structure proximate the three-dimensional semiconductor package, the mold structure comprising: a base material; shielding particles comprising an electrically insulating coating, the shielding particles dispersed in the base material; and silicon dioxide (SiO₂) filler particles dispersed in the base material.

Aspects as in the preceding paragraph provide a device, wherein the shielding particles comprise at least one of boron nitride (BN), bismuth (Bi), bismuth oxide (Bi₂O₃), tantalum nitride (TaN), tungsten nitride (W₃N₂), tin oxide (SnO₂), copper (I) oxide (Cu₂O), or copper (II) oxide (CuO), wherein the electrically insulating coating comprises silicon dioxide (SiO₂), wherein the base material comprises polymer, silicone, polyurethane, chloroprene, butyl, polybutadiene, neoprene, natural rubber, isoprene, resin, or epoxy, and wherein particles in the mold structure comprises 50% to 95% shielding particles and 50% to 5% silicon dioxide (SiO₂) filler particles.

### BRIEF DESCRIPTION OF THE DRAWINGS

The figures illustrate examples of semiconductors that are over-molded with epoxy a radiation blocking material (such as an Ag-Sn alloy) coated with SiO₂, to achieve a level of radiation blocking without needing to use a ceramic package or alter the fabrication process.

FIG. 1 shows a block diagram of a solid state drive (SSD) memory package.

FIG. 2 shows a cross-sectional, side view of a fan-out solution for a SSD memory package.

FIG. 3 shows a cross-sectional, side view of a three-dimensional solution for a SSD memory package.

FIG. 4 is a cross-sectional side view showing an example integrated circuit package including a die mounted on a die carrier, and a mold structure (e.g., a mold encapsulation) at least partially encapsulating the mounted three-dimensional SSD memory package.

FIG. 5 shows a cross-sectional side view of an example integrated circuit package having a three-dimensional SSD memory package on a die carrier and having an encapsulate that encapsulates the three-dimensional SSD memory package, and a mold structure that covers the encapsulate to shield the three-dimensional SSD memory package from radiation.

FIG. 6 shows a cross-sectional side view of an example integrated circuit package having a three-dimensional SSD memory package on a die carrier and having a mold structure encapsulating the three-dimensional SSD memory package, wherein the mold structure comprises layers.

FIG. 7 is an SEM image of a shielding compound with shielding particles coated with an electrical insulator (such as SiO₂), wherein the shielding particles are sphere and colloid particles of various sizes.

FIG. 8 is a phase diagram showing alloys like Ag-Sn.

FIG. 9 is a cross-sectional side view showing an integrated circuit package including a three-dimensional SSD memory package mounted on a die carrier, and a mold structure at least partially encapsulating the mounted three-dimensional SSD memory package, wherein the mold structure has a shielding compound with shielding particles coated with an electrical insulator and filler particles dispersed in a base material.

FIG. 10 is a flow chart of a method of manufacturing a three-dimensional SSD memory package with a shielding mold structure.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

According to an aspect, there is provided a shielding compound to encapsulate dies in packages. The shielding compound includes shielding particles, which are coated to make them electrically nonconductive. The coated shielding particles are dispersed in a base material, for example a polymer such as an epoxy resin.

Aspects provide an integrated radiation protection scheme for datacenter devices with built-in, three-dimensional stacks to mitigate radiation events. An integrated radiation protection scheme may enable the distributed control system (DCS) data-media level data error prevention, especially the ones caused by random events like radiation. Aspects provide DCS data reliability improvements for both memory and storage media with a highly integrated design. Aspects may protect the data system from data integrity loss that can become devastating to the entire DCS caused by radiation. Aspects may protect critical items for DCS employing both double data rate (DDR) volatile memory and solid state drive (SSD) non-volatile memory.

Aspects provide double data rate (DDR) volatile memory that is organized in the “CUBE” format, capable of data caching the solid state drive (SSD) non-volatile memory data while being radiation resistant. Customized ultra-bandwidth elements (CUBE) is a three-dimensional memory package that puts the memory die in the middle between the substrate and the processor, rather than on top. The CUBE DDR volatile memory is a high bandwidth memory (HBM) that uses double data rate (DDR) technology, wherein the “CUBE” comes from it being a three-dimensional stacked architecture resembling a cube or tower of memory chips. DDR is a technology for random access memory (RAM). CUBE is provided by Winbond Electronics Corporation. CUBE is designed to enhance the performance of front-end, three-dimensional structures, such as chip on wafer (CoW) and wafer on wafer (WoW) as well as back-end 2.5D/3D chip on Si-interposer on substrate and fan-out solutions. CUBE is designed for edge AI computing devices and is compatible with memory density from 256 Mb to 8 Gb with a single die. CUBE can be three-dimensionally stacked to enhance bandwidth while reducing data transfer power consumption.

CUBE with built-in double data rate (DDR) volatile memory and microcontroller can have DRAM and NAND in different proportions. For example, the ratio in RT-CUBE (ultra fast Read/Write) can be noted as x:y, where (xGB=DRAM, yGB=NAND). In certain aspects, the ratio may be 1:4. In other aspects, the ratio may be 1:2. In still further aspects, the ratio may be 1:1, particularly when the error correction code (ECC) is above a threshold, then the CUBE-NAND may be increased 100% and the yGB data flash may be backed up into the microcontroller-CUBE DRAM. In that case, the DRAM may be 2×, 4×, 16×, or 1024× faster. The microcontroller may be able to refresh the double data rate (DDR) volatile memory at a rate of 64 milliseconds, 6 milliseconds, 0.06 milliseconds, or 0.64 microseconds.

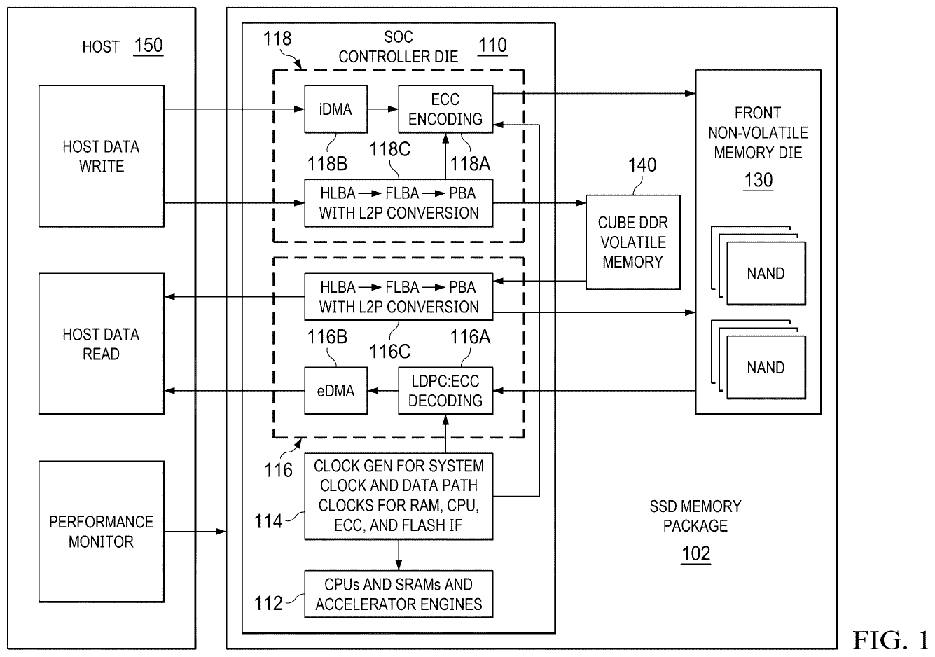

FIG. 1 is a block diagram of a solid state drive (SSD) memory package. The SSD memory package 102 comprises a system on chip (SOC) controller 110, a front non-volatile memory 130, and a CUBE DDR volatile memory 140.

The front non-volatile memory 130 may comprise NAND memory, which is a type of non-volatile flash memory that stores data without a continuous power supply.

The SOC controller 110 comprises: a CPU 112, a clock generator 114, a data read circuit 116, and a data write circuit 118. The clock generator 114 provides a system clock for data path clocks for RAM, CPU, ECC, and flash interrupted function. The data read circuit 116 provides data for the host 150 to read and comprises: a low density parity check (LDPC) with error correction code (ECC) coder 116A; an egress direct memory access eDMA 116B, and a logical to physical converter HLBA 116C. The data write circuit 118 writes data from the host 150 and comprises: an error correction code (ECC) coder 118A; an ingress direct memory access eDMA 118B, and a logical to physical converter HLBA 118C. The error correction code (ECC) coders 116A and 118A are to correct errors in the NAND flash and allowing recovery of data that may be corrupted due to bit errors. The ingress and egress direct memory access 118B and 116B enable the 3-D SSD memory package 102 to move data directly to or from the CUBE DDR volatile memory 140 in the embedded system without intervention by the CPU 112 to allow data handling in the embedded system. The logical to physical converters 116C and 118C convert a host logical block address (HLBA) to a physical block address (PBA).

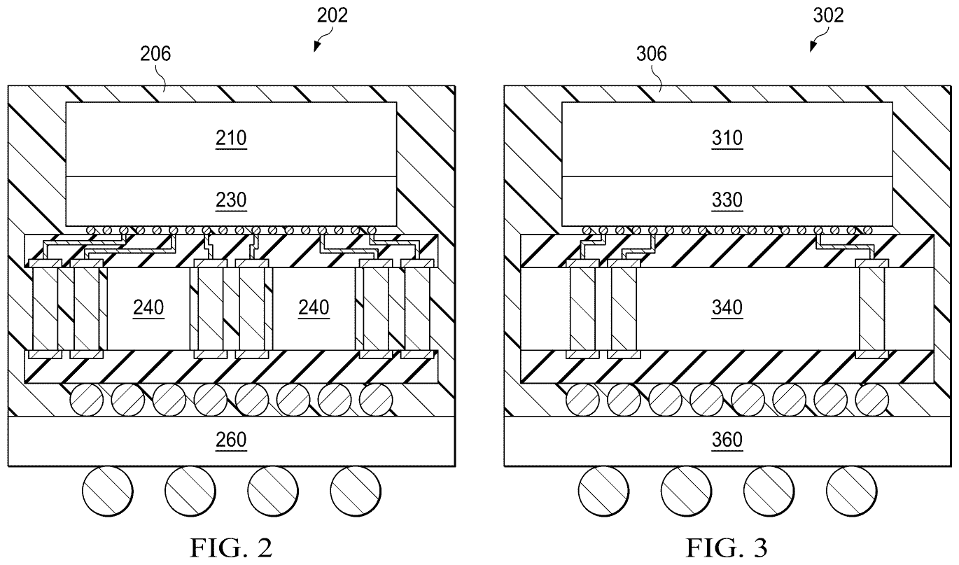

FIG. 2 shows a cross-sectional, side view of a fan-out solution for a SSD memory package 202. The SSD memory package 202 has a package substrate 260. A plurality of CUBE DDR volatile memory dies 240 are mounted to be in signal communication with the package substrate 260. A front non-volatile memory die 230 is mounted to be in signal communication with the plurality of CUBE DDR volatile memory dies 240. A SOC controller die 210 is mounted to be in signal communication with the front non-volatile memory die 230. The dies are encapsulated with a mold structure 206 (e.g., a mold encapsulation) at least partially encapsulating the SSD memory package 202. The mold structure 206 may be proximate the SSD memory package 202.

FIG. 3 shows a cross-sectional, side view of a three-dimensional solution for a SSD memory package 302. The SSD memory package 302 has a package substrate 360. A plurality of CUBE DDR volatile memory dies 340 are mounted to be in signal communication with the package substrate 360. A front non-volatile memory die 330 is mounted to be in signal communication with the plurality of CUBE DDR volatile memory dies 340. A SOC controller die 310 is mounted to be in signal communication with the front non-volatile memory die 330. The dies are encapsulated with a mold structure 306 (e.g., a mold encapsulation) at least partially encapsulating the SSD memory package 302. The mold structure 306 may be proximate the SSD memory package 302.

In alternative aspects, the PCB can have many NAND package stacks on one side.

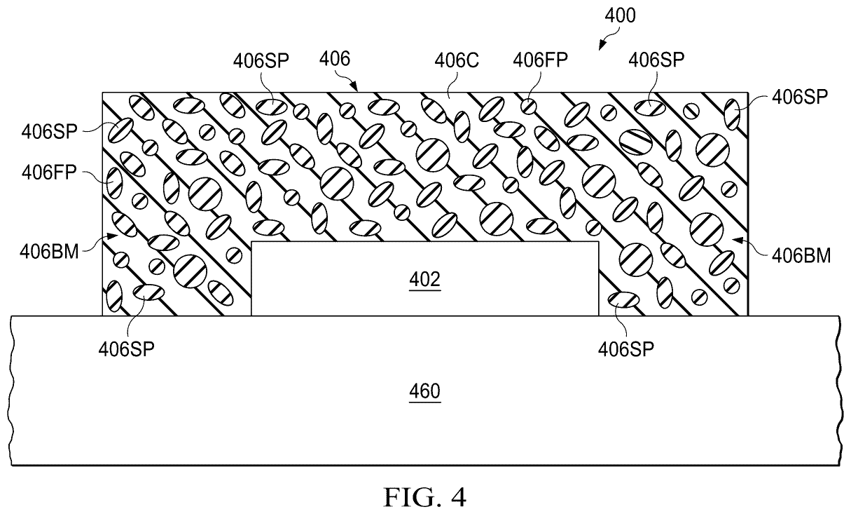

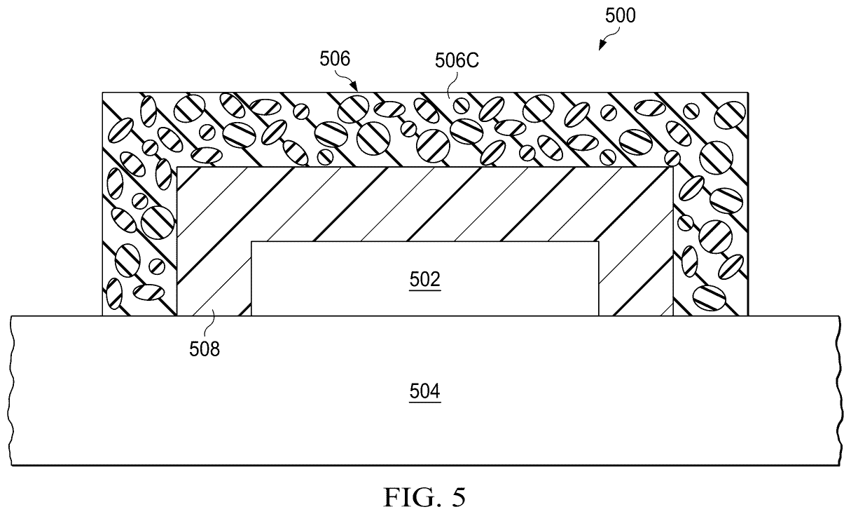

FIG. 4 shows a cross-sectional side view of a SSD memory package 402 mounted on a package substrate 460, and a mold structure 406 (e.g., a mold encapsulation) at least partially encapsulating the SSD memory package 402. The mold structure 406 may be proximate the SSD memory package 402.The SSD memory package 402 may comprise the packages illustrated and described with reference to FIGS. 1-3.

As shown in FIG. 4, in some examples mold structure 406 may comprise a shielding compound 406C includes shielding particles 406SP dispersed in, or otherwise combined, in a base material 406BM, which base material 406BM may be, for example, a polymer such as an epoxy resin or a polymer resin. In some examples, the shielding compound 406C includes a mixture of shielding particles 406SP, filler particles 406FP comprising silicon dioxide (SiO₂) particles, and a base material 406BM comprising an epoxy resin. The mold structure 406 may be proximate the SSD memory package 402 to shield the package from radiation. The shielding compound 406C may resist radiation from alpha, beta, gamma and neutron radiation.

As used herein, a “compound” may refer to one element or substance, or a mixture or other combination of multiple elements or substances. The term particles, as used herein, refers to a particle having a maximum dimension between 1 nanometer and 1000 micrometers, and may be spherical, or colloidal shaped, without limitation. Particles may have a maximum dimension between 1 and 300 micrometers, or 50-80 micrometers. Shielding particles and filler particles are described more fully below.

In some examples the shielding particles 406SP comprise at least one of gold-tin, silver-tin, tungsten, antimony, bismuth, and any heavy metal, without limitation. Heavy metals include metal with high density (for example 5 g/cm³), high atomic weights (for example greater than 63.5gmol-1 ), or atomic numbers greater than 20, such as for example, boron nitride (BN), bismuth (Bi), bismuth oxide (Bi₂O₃), tantalum nitride (TaN), tungsten nitride (W₃N₂), tin oxide (SnO₂), copper (I) oxide (Cu₂O) (i.e., cuprous oxide), or copper (II) oxide (CuO) (i.e., cupric oxide), antimony (Sb), tin (Sn), tungsten (W) particles, without limitation, wherein the heavy metal particles may be coated or encapsulated with an electrically nonconductive material, such as silicon dioxide (SiO₂). The shielding particles 406SP are coated or encapsulated with an electrically nonconductive material, such as silicon dioxide (SiO₂) (also called silica). The shielding particles 406SP may be coated with an electrically nonconductive material to reduce the possibility of an electrical conduction path that could short pins of an integrated circuit package together.

In some examples, the shielding particles 406SP are dispersed in, or otherwise combined with, the base material 406BM. The base material 406BM may comprise, for example, an elastomer (e.g., silicone, polyurethane, chloroprene, butyl, polybutadiene, neoprene, natural rubber or isoprene), a thermoset (e.g., thermoset resin), or other molding compound, which may be supplied in the form of pellets, liquids, or powders, for example. In some examples the shielding particles 406SP may shield the SSD memory package 402 from ionizing radiation, magnetic fields, or a combination of ionizing radiation and magnetic fields. Shielding particles 406SP to shield from magnetic fields may comprise material from the Cobalt oxide family, the Nickle oxide family, the Neodymium oxide family and the Iron oxide family. The shielding particles 406SP may comprise a material from at least one of the Cobalt oxide family, the Nickle oxide family, the Neodymium oxide family, and the Iron oxide family. Shielding particles 406SP to shield from ionizing radiation may include mu-metal or hematite (Fe₂O₃) particles, for example. Thus, shielding particles 406SP need not be uniform, and may comprise a plurality of different types of shielding particles.

The shielding particles 406SP may be coated or encapsulated with an electrically nonconductive material, such as silicon dioxide (SiO₂), by a SOL-GEL process or a spin-on-glass process.

The coated or encapsulated shielding particles 406SP may be dispersed in or otherwise combined with a base material 406BM to produce the shielding compound 406C. In some examples a surfactant may (optionally) be added to enhance or expedite the dispersing of the shielding particles 406SP in the base material 406BM. The shielding particles 406SP (with or without surfactant) may be mixed or combined with the base material 406BM in any suitable manner, e.g., using an agitation or ultrasonic vibration process.

FIG. 5 shows a cross-sectional side view of a package 500 having a SSD memory package 502 on a die carrier 504. An encapsulate 508 encapsulates the SSD memory package 502 and comprises a material that may not shield the SSD memory package 502 from radiation. A mold structure 506, comprising shielding compound 506C covers the encapsulate 508 to shield the SSD memory package 502 from radiation. The illustrated example shows shielding compound 506C formed over encapsulate 508. Shielding compound 506C is similar in all respects to shielding compound 406C described above with reference to FIG. 4. The mold structure 506 may be proximate the SSD memory package 502 to shield the SSD memory package 502 from radiation.

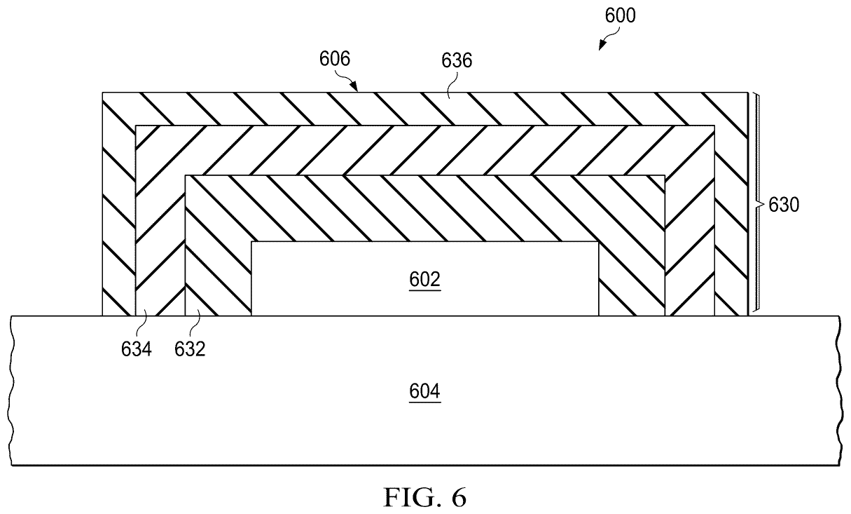

FIG. 6 shows a cross-sectional side view of a package 600 having a SSD memory package 602 on a die carrier 604 with a mold structure 606 comprising three shielding layers 630. Other examples, not shown, include a single shielding layer, two shielding layers, or three, or more, shielding layers. Respective shielding layer(s) may include shielding particles dispersed in or otherwise combined with a base material. For example, respective shielding layer(s) may include shielding particles to shield the SSD memory package 602 from ionizing radiation, magnetic fields, or a combination of ionizing radiation and magnetic fields, e.g., as discussed above regarding shielding compound 406C, with reference to FIG. 1. The mold structure 606 may be proximate the SSD memory package 602 to shield the SSD memory package 602.

In examples with multiple shielding layers, different shielding layers 630 may include different types or different concentrations of shielding particles. For example, referring to the example shown in FIG. 6, shielding layer 632 may comprise magnetic shielding particles (e.g., to shield SSD memory package 602 from magnetic fields) and shielding layer 634 may comprise shielding particles (e.g., to shield SSD memory package 602 from ionic radiation). As another example, shielding layers 632, 634, and 636 may comprise the same type of particles (e.g., magnetic shielding particles or shielding particles) but with a respective different concentration of particles, to thereby define a shielding gradient along a direction toward or away from the SSD memory package 602. For example, the shielding layers 632, 634, and 636 may provide an increasing degree of shielding in a direction toward the SSD memory package 602 (e.g., wherein the shielding layer 632, which may be termed inner shielding layer 632, may provide a greater degree of shielding than shielding layer 636, which may be termed outer shielding layer 636). While three shielding layers 630 are shown in FIG. 6, any number of shielding layers may be used, without limitation, and individual layers may have any ratio of shielding particles to filler particles, without limitation. The shielding particles of the respective ones of shielding layers 630, may be coated or encapsulated with an electrically nonconductive material, such as silicon dioxide (SiO₂).

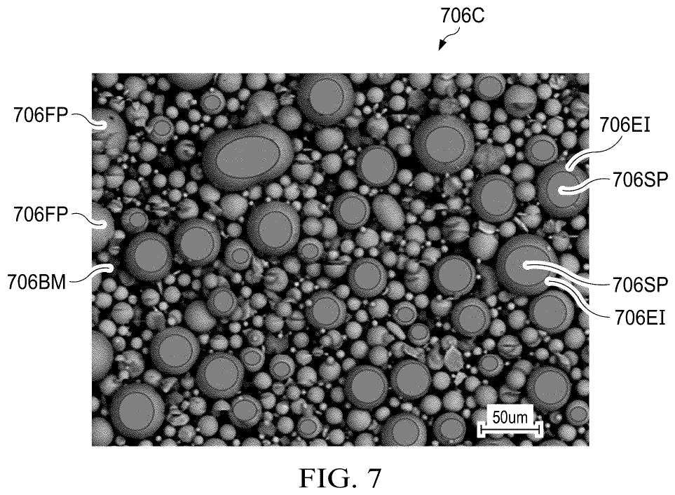

FIG. 7 is an scanning electron microscope (SEM) of a shielding compound 706C with shielding particles 706SP dispersed in a base material 706BM. The shielding particles 706SP are shown in cross-section to show that they are coated with an electrical insulator 706EI (such as silicon dioxide (SiO₂)), wherein the shielding particles 706SP are sphere and colloid particles of various sizes. Filler particles 706FP may also be dispersed in the shielding compound 706C. The filler particles 706FP may thicken or otherwise enhance the structural integrity of the base material 706BM.

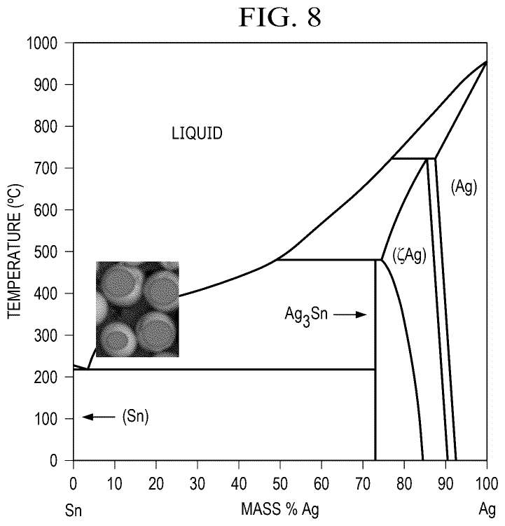

FIG. 8 is a phase diagram showing alloys like Ag-Sn allow for dialing in the radiation blocking ability while being able to hold up to processing temperatures and the mission profile of the end device. Sn has more effective radiation blocking properties than Ag. However, Sn has a relatively low melting point and may not hold up to processing temperatures by itself. By increasing the % of Ag in the alloy with Sn, the melting point increases. In some aspects, a high percentage of Sn compared to Ag may be used so the alloy will effectively block radiation without melting during package processing.

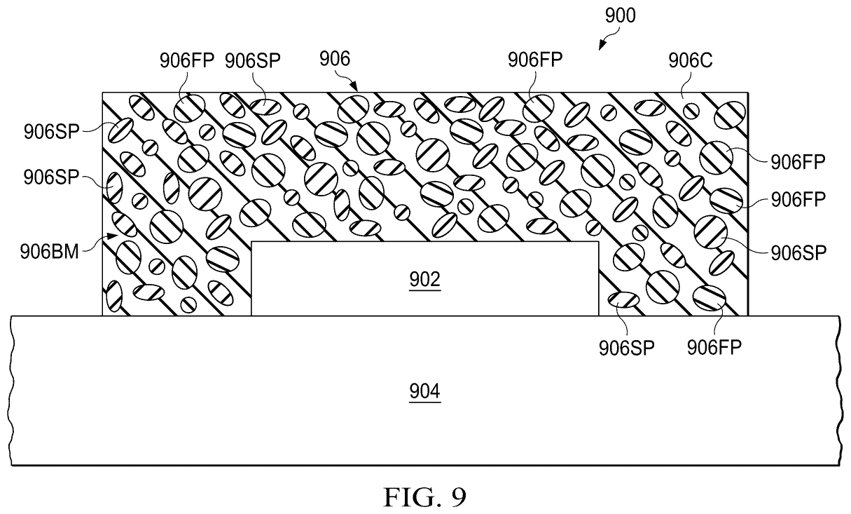

FIG. 9 is a cross-sectional side view showing an example integrated circuit package 900 including a SSD memory package 902 mounted on a die carrier 904, and a mold structure 906 (e.g., a mold encapsulation) at least partially encapsulating the mounted SSD memory package 902. As shown in FIG. 9, the mold structure 906 comprises a shielding compound 906C, which includes shielding particles 906SP dispersed in a base material 906BM, for example a polymer such as an epoxy resin. The shielding compound 906C also includes filler particles 906FP (e.g., in the form of fumed silicon dioxide (SiO₂) or colloidal silicon dioxide (SiO₂)) to thicken or otherwise enhance the structural integrity of the base material 906BM (e.g., epoxy). Thus, the shielding compound 906C may include shielding particles 906SP and filler particles 906FP dispersed in, or otherwise combined with, base material 906BM. In one example, the particles may comprise 90%-95% shielding particles 906SP and 10%-5% filler particles in the shielding compound 906C. In another example, particles may comprise 50%-95% shielding particles 406SP and 50%-5% filler particles 906FP in the shielding compound 906C.

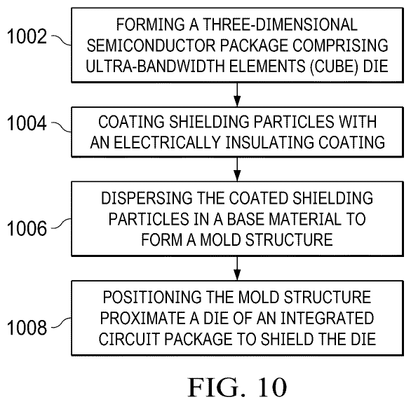

FIG. 10 shows a flow chart of a method. A three-dimensional semiconductor package is formed 1002 comprising a customized ultra-bandwidth elements (CUBE) die. Shielding particles are coated 1004 with an electrically insulating coating. The coated shielding particles are dispersed 1006 in a base material to form a mold structure. The mold structure is positioned 1008 proximate a die of an integrated circuit package to shield the die from ionic radiation.

Although examples have been described above, other variations and examples may be made from this disclosure without departing from the spirit and scope of these disclosed examples.

1. A method comprising:
forming a three-dimensional semiconductor package comprising a customized ultra-bandwidth elements (CUBE) die:
coating shielding particles with an electrically insulating coating;
dispersing the coated shielding particles in a base material to form a mold structure; and
positioning the mold structure proximate the three-dimensional semiconductor package.

2. The method as in claim 1, wherein forming a three-dimensional semiconductor package comprises:
providing a package substrate;
mounting a CUBE die in signal communication with the package substrate, wherein the CUBE die comprises double data rate (DDR) volatile memory;
mounting a front die in signal communication the CUBE die, wherein the front die comprises NAND memory cells; and
mounting a controller die in signal communication with the front die.

3. The method as in claim 1, wherein the CUBE die comprises DRAM and NAND in a ratio of 1:4, 1:2, or 1:1, and wherein the CUBE die comprises double data rate (DDR) volatile memory with a refresh rate of 64 milliseconds, 6 milliseconds, 0.06 milliseconds, or 0.64 microseconds.

4. The method as in claim 1, wherein the shielding particles comprise at least one of boron nitride (BN), bismuth (Bi), bismuth oxide (Bi₂O₃), tantalum nitride (TaN), tungsten nitride (W₃N₂), tin oxide (SnO₂), copper (I) oxide (Cu₂O), or copper (II) oxide (CuO).

5. The method as in claim 1, wherein the shielding particles comprise a material from at least one of the Cobalt oxide family, the Nickle oxide family, the Neodymium oxide family, and the Iron oxide family.

6. The method as in claim 1, wherein the electrically insulating coating comprises silicon dioxide (SiO₂).

7. The method as in claim 1, wherein the base material comprises polymer, silicone, polyurethane, chloroprene, butyl, polybutadiene, neoprene, natural rubber, isoprene, resin, or epoxy.

8. The method as in claim 1, comprising dispersing a plurality of silicon dioxide (SiO₂) filler particles in the base material to form the mold structure, wherein dispersed particles comprise 50% to 95% shielding particles and 50% to 5% silicon dioxide filler particles.

9. The method as in claim 1, wherein positioning the mold structure proximate the three-dimensional semiconductor package comprises comprising positioning first and second shielding layers, wherein the first and second shielding layers comprise different concentrations of the coated shielding particles.

10. A device comprising:
a three-dimensional semiconductor package comprising a CUBE die; and
a mold structure proximate the three-dimensional semiconductor package, the mold structure comprising:
a base material; and
shielding particles comprising an electrically insulating coating, wherein the shielding particles are dispersed in the base material.

11. The device as in claim 10, wherein the three-dimensional semiconductor package comprises:
a package substrate;
a CUBE die in signal communication with the package substrate, wherein the CUBE die comprises double data rate (DDR) volatile memory;
a front die in signal communication the CUBE die, wherein the front die comprises NAND memory cells; and
a controller die in signal communication with the front die.

12. The device as in claim 10, wherein the CUBE die comprises DRAM and NAND in a ratio of 1:4, 1:2, or 1:1, and wherein the CUBE die comprises double data rate (DDR) volatile memory with a refresh rate of 64 milliseconds, 6 milliseconds, 0.06 milliseconds, or 0.64 microseconds.

13. The device as in claim 10, wherein the shielding particles comprise at least one of boron nitride (BN), bismuth (Bi), bismuth oxide (Bi₂O₃), tantalum nitride (TaN), tungsten nitride (W₃N₂), tin oxide (SnO₂), copper (I) oxide (Cu₂O), or copper (II) oxide (CuO).

14. The device as in claim 10, wherein the shielding particles comprise a material from at least one of the Cobalt oxide family, the Nickle oxide family, the Neodymium oxide family, and the Iron oxide family.

15. The device as in claim 10, wherein the electrically insulating coating comprises silicon dioxide (SiO₂).

16. The device as in claim 10, wherein the base material comprises a material selected from polymer, silicone, polyurethane, chloroprene, butyl, polybutadiene, neoprene, natural rubber, isoprene, resin, and epoxy.

17. The device as in claim 10, wherein the mold structure comprises silicon dioxide (SiO₂) filler particles, wherein particles in the mold structure comprise 50% to 95% shielding particles and 50% to 5% silicon dioxide (SiO₂) filler particles.

18. The device as in claim 10, comprising an encapsulate at least partially encapsulating the three-dimensional semiconductor package, wherein the mold structure is proximate the encapsulate.

19. The device as in claim 10, wherein the mold structure comprises first and second shielding layers, wherein the first and second shielding layers comprise different concentrations of shielding particles.

20. A system comprising:
a three-dimensional semiconductor package comprising:
a package substrate;
a CUBE die in signal communication with the package substrate, wherein the CUBE die comprises double data rate (DDR) volatile memory;
a front die in signal communication the CUBE die, wherein the front die comprises NAND memory cells; and
a controller die in signal communication with the front die; and
a mold structure proximate the three-dimensional semiconductor package, the mold structure comprising:
a base material;
shielding particles comprising an electrically insulating coating, the shielding particles dispersed in the base material; and
silicon dioxide (SiO₂) filler particles dispersed in the base material.

21. The system as in claim 20,
wherein the shielding particles comprise at least one of boron nitride (BN), bismuth (Bi), bismuth oxide (Bi₂O₃), tantalum nitride (TaN), tungsten nitride (W₃N₂), tin oxide (SnO₂), copper (I) oxide (Cu₂O), or copper (II) oxide (CuO),
wherein the electrically insulating coating comprises silicon dioxide (SiO₂),
wherein the base material comprises polymer, silicone, polyurethane, chloroprene, butyl, polybutadiene, neoprene, natural rubber, isoprene, resin, or epoxy, and
wherein particles in the mold structure comprises 50% to 95% shielding particles and 50% to 5% silicon dioxide (SiO₂) filler particles.
